(19) United States
(12) Patent Application Publication
(10) Pub. No.: US 2026/0114663 A1
(43) Pub. Date: Apr. 30, 2026

(54) BAKING ASSISTIVE DEVICE FOR NOVICE BAKERS

(71) Applicant: Imam Abdulrahman Bin Faisal University, Dammam (SA)

(72) Inventors: Alhawra Mohsen ALSHAKHOURI, Dammam (SA); Khadijah KHUWAITEM, Dammam (SA); Amal ALKHAYAL, Dammam (SA); Saleha HUMAID, Dammam (SA); Maryam GHAZWI, Dammam (SA)

(73) Assignee: Imam Abdulrahman Bin Faisal University, Dammam (SA)

(21) Appl. No.: 18/930,783

(22) Filed: Oct. 29, 2024

(51) Int. Cl. A47J 36/32; A47J 43/046; A47J 43/07

(52) U.S. Cl. CPC A47J 36/321; A47J 43/046; A47J 43/0727; A47J 2043/0733; A47J 2202/00

(57) ABSTRACT

A baking assistance device, a baking assistance system and a method using thereof are described, for improving consistency and quality in home baking. The baking assistance device comprises a base structure with a hollow interior, a cover ring, a curved arm connected to the cover ring, a support ring, an LED light ring, a stainless steel plate, a translucent light diffuser ring, an LCD display module, a touch screen, an infrared temperature sensor, a near field communications unit, a load cell, and a microprocessor. The microprocessor, connected to various components, displays weight, temperature, and recipe information on the LCD display. The baking assistance device integrates multiple baking functions including weighing ingredients, measuring temperature, and providing recipe guidance. Further, the connectivity features of the baking assistance device provide integration with smartphones and baking applications, enhancing functionality and user experience.

### BACKGROUND

### Technical Field

The present disclosure relates to a multi-functional baking assistive device designed to aid novice home bakers in achieving consistent and high-quality baked goods.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Baking is a popular culinary activity enjoyed by many individuals in home settings. The process of baking typically involves several stages, including ingredient preparation, mixing, and cooking, each requiring specific skills and attention to detail. With the rise of interest in home baking, there has been an increased focus on achieving professional quality results in domestic kitchens. However, novice bakers often face challenges in maintaining consistency and quality in their baked goods. Factors such as ingredient measurement accuracy, temperature control, and timing can significantly impact the final product. These variables frequently lead to inconsistent results, even when following the same recipe multiple times. Additionally, the lack of immediate feedback during the baking process can make it difficult for novice bakers to identify and correct issues as they arise.

Conventional solutions to address these challenges include traditional kitchen tools such as measuring cups, kitchen scales, and standalone thermometers. More advanced options include programmable stand mixers, proofing boxes, and smart ovens. Recipe books and online tutorials also provide guidance on baking techniques and best practices. While these existing tools and methods offer some support, they have limitations in effectively addressing the comprehensive needs of novice bakers. Many require a certain level of expertise to use effectively, and few provide real-time feedback or guidance during critical stages of the baking process. Furthermore, most existing solutions focus on individual aspects of baking rather than offering an integrated approach that covers multiple functions.

US20200367692A1 describes a cooking assistance appliance for use with a cooking appliance. The cooking assistance appliance can communicate wirelessly with the cooking appliance. The cooking assistance appliance can display recipes, warnings, timers, volume information, cooking temperature, doneness, or discrete cooking instructions. However, this cooking assistance appliance is not an integrated system, instead is for communication with a cooking appliance, like a cooking range. The present disclosure provides an integrated, standalone baking assistive device, which combines multiple functions into a single unit specifically tailored for baking, rather than general cooking, and offers real-time guidance throughout the baking process.

US20230213200A1 describes a food cooking unit with gas burners, a weight sensor, an infrared sensor, and an interface having buttons. The food cooking unit can notify users about ingredient quantities and incorporate new recipes via wireless communication. However, this food cooking unit is not particularly designed for baking applications, as it does not provide mixing related instructions for preparing the ingredients for baking. The present disclosure provides an integrated, standalone baking assistive device, which combines multiple functions into a single unit specifically tailored for baking, rather than general cooking, and offers real-time guidance throughout the baking process.

CN108567319A describes a household cooking auxiliary system, comprising a weighing sensor, an infrared sensor, and a central processor connected to a display screen to show food temperature and ingredient weight. However, there is no discussion of assistance in preparing recipes or a recipe app in communication with the system.

“AI cooking assistant” describes a cooking device with a weight scale that communicates with a touchscreen display, showing selectable recipes and cooking guidance. The device includes a connected cooking pot with temperature control, chopping blade, and stirrer. The device is wirelessly connected to a smartphone app with a chatbox for recipe information. However, this cooking device is not particularly designed for baking applications, as it does not provide a display showing steps for mixing and related instructions for preparing the ingredients for baking. The present disclosure provides an integrated, standalone baking assistive device, which combines multiple functions into a single unit specifically tailored for baking, rather than general cooking, and offers real-time guidance throughout the baking process.

Each of the aforementioned references suffers from one or more drawbacks hindering their adoption, such as lack of integration, focus on general cooking rather than baking, or limited real-time guidance capabilities. Accordingly, it is one object of the present disclosure to provide a baking assistive device and a method for preparing a recipe using a baking assistive system which integrate multiple functions, including precise ingredient weighing, temperature measurement, and real-time recipe guidance, into a standalone, user-friendly unit, optionally to be used with a smartphone, and specifically designed to support novice bakers throughout the entire baking process.

### SUMMARY

In an exemplary embodiment, a baking assistive device is described, comprising a base structure having a hollow interior; a cover ring located over the base structure; a curved arm having a first end connected to the cover ring; a support ring located over the cover ring; an LED light ring located over the support ring; a stainless steel plate located on the LED light ring; a translucent light diffuser ring located on the stainless steel plate; an LCD display module located on an exterior surface of the base structure; a touch screen connected to a second end of the curved arm; an infrared temperature sensor located near the second end of the curved arm; a near field communications unit located within the hollow interior of the base structure; a load cell located within the hollow interior of the base, wherein the load cell is configured to record a weight based on a depression of the stainless steel plate; and a microprocessor located within the hollow interior of the base structure, wherein the microprocessor is connected to the load cell, the infrared temperature sensor, the near field communications unit, the LCD display module and the touch screen, wherein the microprocessor is configured to display the weight, a temperature and a recipe information message on a display screen of the LCD display module.

In another exemplary embodiment, a baking assistive system is described, comprising a baking assistive device including a near field communications unit; a smartphone configured with a baking assistive computer application, wherein the smartphone is configured to pair with the baking assistive device over a near field communication channel; a recipe database connected to the smartphone, wherein the recipe database includes recipes having recipe ingredients and recipe instructions for preparing a recipe selection; a display located on the smartphone which is configured to display the recipe selection and the recipe ingredients; a microprocessor located within a hollow interior of a base structure of the baking assistive device, wherein the microprocessor is connected to the near field communications unit and is configured to receive the recipe ingredients and the recipe instructions; an LCD display module located on an exterior surface of the base structure of the baking assistive device, wherein the LCD display module is operatively connected to the microprocessor, wherein the microprocessor is configured to display the recipe instructions for preparing the recipe selection on the LCD display module.

In yet another exemplary embodiment, a method for preparing a recipe using a baking assistive system is described, comprising pairing, over a near field communication channel, a baking assistive device with a smartphone configured with a baking assistive computer application; accessing, by the baking assistive computer application, a recipe database, wherein the recipe database includes recipes having recipe ingredients and recipe instructions for preparing a plurality of selectable recipes; prompting, on a display located on the smartphone, a user to select one of the plurality of selectable recipes; transmitting, over the near field communication channel, the recipe ingredients and recipe instructions to the baking assistive device; displaying, on an LCD display module of the baking assistive device, a recipe ingredient and a desired weight of the recipe ingredient; prompting, on the LCD display module, the user to add the recipe ingredient to a mixing bowl located on a stainless steel plate connected to a load cell; weighing, by the load cell, the mixing bowl until the weight of the recipe ingredient matches the desired weight; emitting, by an LED light ring located beneath the stainless steel plate, a red light as the recipe ingredient is added and emitting a blue light when the weight of the recipe ingredient matches the desired weight; receiving, on a touch screen of the baking assistive device, an input from the user to move to a next step for preparing the recipe; displaying, on the display of the smartphone, a next recipe ingredient; displaying, on the LCD display module of the baking assistive device, a desired weight of the recipe ingredient; adding, by the user, the next recipe ingredient to the mixing bowl until the LED light ring emits the blue light; displaying, on the LCD display module of the baking assistive device, a mixing duration of the next recipe ingredient; and continuing to add and mix recipe ingredients to the mixing bowl until the all of the recipes ingredients have been added.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a side perspective view of a baking assistive device, according to certain embodiments.

FIG. 1B is a top perspective view of the baking assistive device, according to certain embodiments.

FIG. 1C is a front perspective view of the baking assistive device, according to certain embodiments.

FIG. 1D is a side planar view of the baking assistive device, according to certain embodiments.

FIG. 1E is an exploded perspective view of the baking assistive device, showing its various components, according to certain embodiments.

FIG. 2A is a perspective diagram depicting implementation of the baking assistive device with a small-sized mixing bowl, according to certain embodiments.

FIG. 2B is a perspective diagram depicting implementation of the baking assistive device with a large-sized mixing bowl, according to certain embodiments.

FIG. 3 is an exemplary diagram of a touch screen interface of the baking assistive device, according to certain embodiments.

FIG. 4 is an exemplary diagram of a LCD display module of the baking assistive device, according to certain embodiments.

FIG. 5 is a diagram depicting implementation of the baking assistive device with a smartphone configured with a baking assistive computer application, according to certain embodiments.

FIG. 6 is an exemplary flowchart listing steps involved in a method for preparing a recipe using the baking assistive system, according to certain embodiments.

FIG. 7A is an exemplary diagram illustrating a first usage scenario of the baking assistive device, according to certain embodiments.

FIG. 7B is an exemplary diagram illustrating a second usage scenario of the baking assistive device, according to certain embodiments.

FIG. 7C is an exemplary diagram illustrating a third usage scenario of the baking assistive device, according to certain embodiments.

FIG. 7D is an exemplary diagram illustrating a fourth usage scenario of the baking assistive device, according to certain embodiments.

FIG. 8 is an illustration of a non-limiting example of details of computing hardware used in a microprocessor of the baking assistive device, according to certain embodiments.

FIG. 9 is an exemplary schematic diagram of a data processing system used within the microprocessor, according to certain embodiments.

FIG. 10 is an exemplary schematic diagram of a processor used with the microprocessor, according to certain embodiments.

FIG. 11 is an illustration of a non-limiting example of distributed components which may share processing with a controller, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

Aspects of this disclosure are directed to a baking assistive device that integrates multiple functions to support novice home bakers in achieving consistent, high-quality results. The baking assistive device of the present disclosure combines precise ingredient weighing, non-contact temperature measurement, and intuitive user guidance into a single, compact unit. Unlike traditional kitchen scales or standalone appliances, the baking assistive device provides real-time feedback throughout the baking process helping users make informed decisions at each stage, while its data logging capabilities support skill development over time. The baking assistive device aims to improve the overall baking experience by providing user-friendly interface and visual feedback system, making it accessible to bakers of all skill levels.

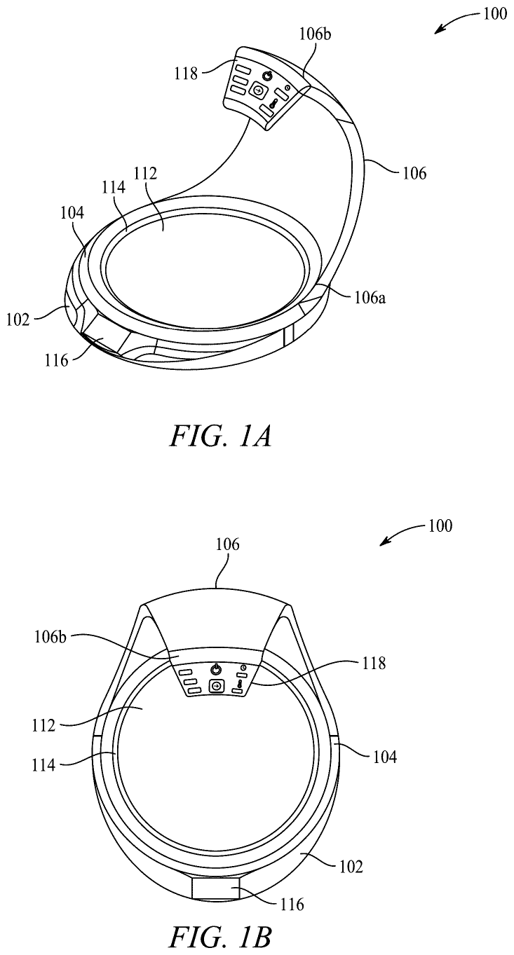

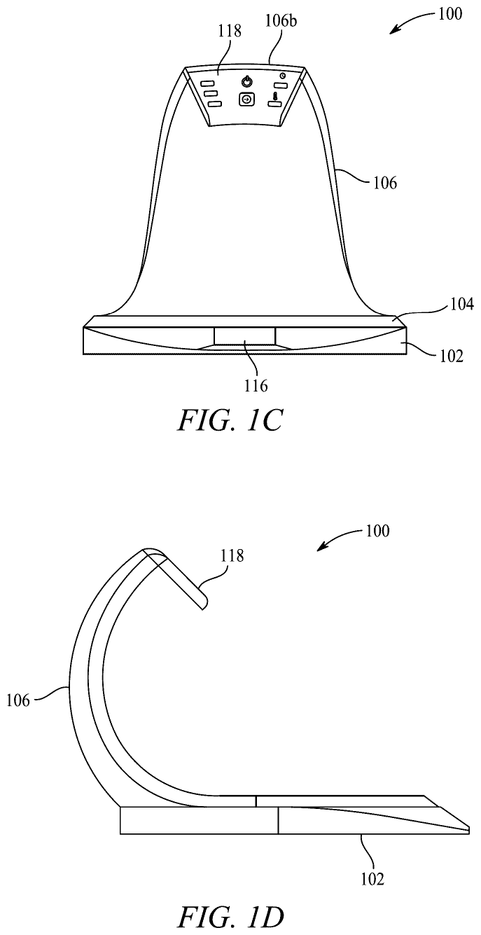

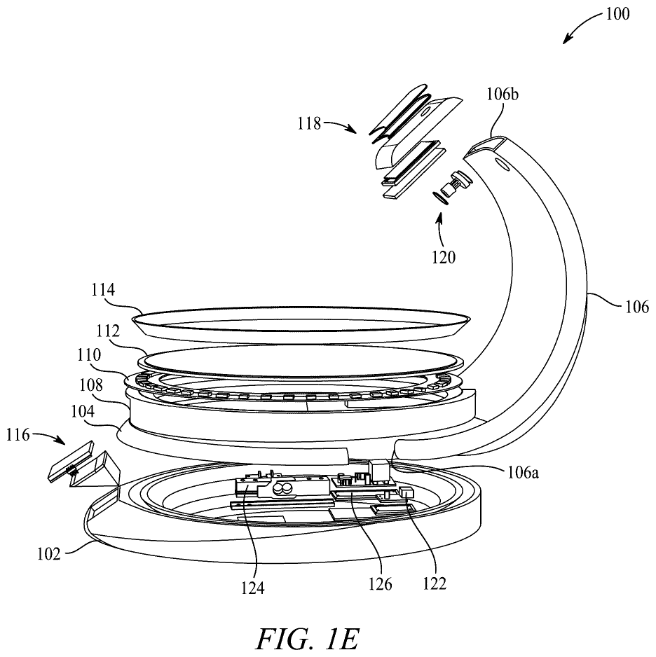

Referring to FIGS. 1A-1E in combination, illustrated are different views of a baking assistive device (as represented by reference numeral 100), where FIG. 1A is a side perspective view of a baking assistive device, FIG. 1B is a top perspective view of the baking assistive device, FIG. 1C is a front perspective view of the baking assistive device, FIG. 1D is a side planar view of the baking assistive device, and FIG. 1E is an exploded perspective view of the baking assistive device, showing its various components. The baking assistive device 100 is a multi-functional device designed to support novice home bakers in achieving consistent and high-quality baked goods. The baking assistive device 100 implements a modern and utilitarian design and provides positioning of components without interfering with the baking workspace. The baking assistive device 100 provides smart features, including ability to communicate with smartphones, and integrated sensors to extends its functionality, providing features such as recipe storage, personalized guidance, progress tracking over time, and active assistance throughout the baking process. The baking assistive device 100 offers integration of multiple functions into a single, aesthetically pleasing unit makes it a valuable addition to any home kitchen, potentially transforming the way people approach home baking.

As illustrated, the baking assistive device 100 includes several interconnected components that work together to provide a comprehensive baking solution. Each element plays a role in the overall functionality and user experience of the baking assistive device 100. The baking assistive device 100 includes a base structure 102 having a hollow interior. The base structure 102 serves as the foundation of the baking assistive device 100, housing various internal components and providing a stable platform for baking operations. The hollow interior (as better shown in FIG. 1E) facilitates efficient organization of electronic components and contributes to overall compact design of the baking assistive device 100. The base structure 102 may be made of a durable, food-safe material such as ABS plastic with a glossy paint finish, ensuring longevity and ease of cleaning, without any limitations.

The baking assistive device 100 further includes a cover ring 104 located over the base structure 102. The base structure has an oval shape which tapers inward on a front side. The tapered surface increases the amount of space available for the LCD display module 116 and tilts the LCD module into an easily viewed position. The cover ring 104 provides a transition between the base structure 102 and upper components of the baking assistive device 100. The cover ring 104 also enhances the aesthetic appeal of the baking assistive device 100 and helps protect the internal components from dust and spills. The cover ring 104 is designed to be easily removable for maintenance and cleaning purposes. In some examples, the base structure 102 may include a groove (as better shown in FIG. 1E) formed therein, onto which the cover ring 104 may be attached (such as, snap into place), for easy assembly and removal.

The baking assistive device 100 further includes a curved arm 106. The curved arm 106 has a first end 106a and a second end 106b, with the first end 106a connected to the cover ring 104. The curved arm 106 rises from the base structure 102, creating an ergonomic and aesthetically pleasing design. As shown in FIG. 1E, the curved arm 106 may have a portion attached to the said groove within the base structure 102, and another portion extending upwards forming a curved structure. Such design enhances visual appeal of the baking assistive device 100 and provides space for positioning of sensors and interface elements which improves user comfort and functionality (as will be described in more detail in the proceeding paragraphs).

The baking assistive device 100 further includes a support ring 108 located over the cover ring 104. The support ring 108 provides additional structural integrity to the baking assistive device 100 and serves as a mounting point for other components therein. The baking assistive device 100 further includes an LED light ring 110 located over the support ring 108. The LED (light emitting diode) light ring 110 serves as a visual feedback system, using different colors and patterns to communicate various states and alerts to the user during the baking process. For example, the LED light ring 110 may emit a certain colored light when ingredients are at the correct temperature and a different colored light otherwise or may even emit light pulses to indicate some predefined action. As shown, the LED light ring 110 is positioned to be disposed along outer boundary of the cover ring 104 to be visible from various angles, ensuring that users can receive such visual feedback regardless of their position relative to the baking assistive device 100.

The baking assistive device 100 further includes a stainless steel plate 112 located on the LED light ring 110. The stainless steel plate 112 forms the main working surface of the baking assistive device 100. The stainless steel material is chosen for its durability, ease of cleaning, and ability to withstand high temperatures. The baking assistive device 100 further includes a translucent light diffuser ring 114 located on the stainless steel plate 112. The translucent light diffuser ring 114 helps to evenly distribute the light from the LED light ring 110, creating a soft, uniform glow that is both functional and aesthetically pleasing. The translucent light diffuser ring 114 is made of a food-safe, heat-resistant polycarbonate material, ensuring durability and safety during baking operations.

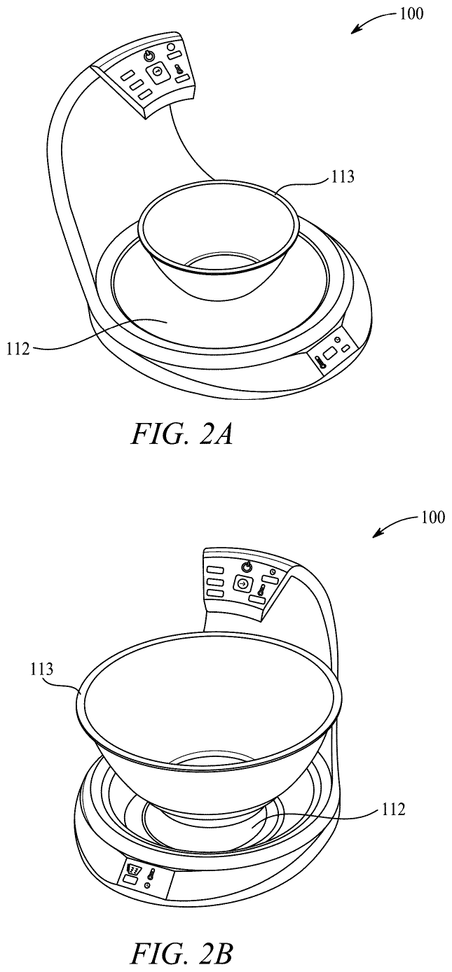

The baking assistive device 100 is designed to work with at least one mixing bowl 113 (as illustrated in FIGS. 2A and 2B). Each mixing bowl 113 is configured to rest upon the stainless steel plate 112 of the baking assistive device 100. The stainless steel plate 112 serves as a stable and level surface for supporting the mixing bowl 113 during the baking process. The mixing bowl 113 is intended to receive at least one recipe ingredient during the baking process. The stainless steel plate 112 is designed to accommodate mixing bowls 113 of various sizes, providing versatility in recipe preparation and batch sizes. For instance, as shown in FIG. 2A, the mixing bowl 113 may be of a small-size; or as shown in FIG. 2B, the mixing bowl 113 may be of a large-size; as may be required and limited based on maximum size that could be accommodated on the stainless steel plate 112. In an embodiment, various sized mixing bowls may be provided within the packaging of the baking assistive device or as a related purchase item at point of sale.

Referring back to FIGS. 1A-1E, as illustrated, the baking assistive device 100 also includes an LCD display module 116 located on an exterior surface of the base structure 102. The LCD (liquid crystal display) display module 116 is configured to display information to the user, including weight measurements, temperature readings, timer status, and recipe information. The LCD display module 116 is designed to be easily visible from various angles, ensuring that users can read the information even while engaged in baking activities. The baking assistive device 100 also includes a touch screen 118 connected to the second end 106b of the curved arm 106. The touch screen 118 serves as an interactive interface, facilitating users to input commands, select functions, and navigate through various features of the baking assistive device 100. The touch screen 118 is configured to be responsive and intuitive, featuring large, easy-to-press buttons for functions such as tare, temperature measurement, and timer control.

The baking assistive device 100 further includes an infrared temperature sensor 120 located near the second end 106b of the curved arm 106. The infrared temperature sensor 120 facilitates quick and accurate non-contact temperature measurements of ingredients or batter placed on the stainless steel plate 112, such as in the mixing bowl 113. The infrared temperature sensor 120 is positioned at an angle to ensure accurate readings without interfering with the baking process. The baking assistive device 100 also includes a near field communications unit 122 located within the hollow interior of the base structure 102. The near field communications unit 122 equips the baking assistive device 100 to communicate with smartphones and other NFC-enabled devices, facilitating features such as recipe transfer, data logging, and integration with baking applications.

The baking assistive device 100 further includes a load cell 124 located within the hollow interior of the base structure 102. In the present configuration, the stainless steel plate 112 is designed to be slightly depressible, working in conjunction with the load cell 124 for weight measurement. The load cell 124 is configured to record a weight based on a depression of the stainless steel plate 112. The load cell 124 facilitates accurate measurement of ingredients or batter placed on the stainless steel plate 112, such as in the mixing bowl 113. The load cell 124 operates by detecting minute changes in electrical resistance when the stainless steel plate 112 is depressed by the weight of ingredients, converting this information into accurate weight measurements.

Specifically, the load cell 124 is configured to record the weight of the at least one recipe ingredient as the recipe ingredient is received within the mixing bowl 113. As ingredients are added to the mixing bowl 113, the weight increase causes a corresponding depression of the stainless steel plate 112. This depression is detected by the load cell 124, which converts the mechanical force into an electrical signal. The electrical signal is then processed (as discussed later) to determine the precise weight of the added ingredients. This configuration facilitates real-time weight measurement as ingredients are added to the mixing bowl 113, supporting users in achieving accurate measurements for recipe preparation. As discussed, in the present configuration, the baking assistive device 100 can accommodate different sizes (and thereby weights) of mixing bowls 113. The load cell 124 may be configured to automatically account for the weight of the mixing bowl 113 itself, to be able to accurately record the weight of the recipe ingredient received within the mixing bowl 113.

In an aspect, the curved arm 106 has a curvature of about 45 degrees and is about 230 cm in height. This specific curvature is designed to provide a balance between ergonomic positioning of the touch screen 118 and the infrared temperature sensor 120, while maintaining a compact overall profile of the baking assistive device 100. The curved arm 106 is about 230 cm in height, measured from the base structure 102 to the second end 106b. This height is selected to position the touch screen 118 and other interface elements at a comfortable level for most users, providing for easy interaction while standing at a typical kitchen counter. Further, the touch screen 118 extends at an angle of about 90 degrees from the second end 106b of the curved arm 106. This perpendicular orientation of the touch screen 118 relative to the curved arm 106 provides optimal visibility and accessibility for the user. The 90-degree angle ensures that the touch screen 118 faces the user directly when they are standing in front of the baking assistive device 100, facilitating easy reading of displayed information and comfortable interaction with the touch interface. Further, in an aspect, the infrared temperature sensor 120 is installed at an angle on the second end 106b of the curved arm 106. This specific angle of installation for the infrared temperature sensor 120 is purposely selected and designed to focus an infrared beam on the recipe ingredients located in the center of the mixing bowl 113. The angled positioning ensures that the infrared temperature sensor 120 can accurately measure the temperature of the ingredients without physical contact, regardless of the size or depth of the mixing bowl 113 being used.

The baking assistive device 100 further includes a microprocessor 126 located within the hollow interior of the base structure 102. The microprocessor 126 serves as the central processing unit of the baking assistive device 100, coordinating and controlling all electronic components and functions. In the baking assistive device 100, the microprocessor 126 is connected to the load cell 124, the infrared temperature sensor 120, the near field communications unit 122, the LCD display module 116, and the touch screen 118. Such interconnected configuration supports the microprocessor 126 to receive, process, and transmit data between various components of the baking assistive device 100.

In particular, the microprocessor 126 is configured to display the weight, a temperature, and a recipe information message on a display screen of the LCD display module 116. For this purpose, when ingredients are placed on the stainless steel plate 112 (such as, in the mixing bowl 113), the load cell 124 sends weight data to the microprocessor 126, which then processes this information and displays the weight on the LCD display module 116. Similarly, temperature readings from the infrared temperature sensor 120 are processed by the microprocessor 126 and displayed on the LCD display module 116. The microprocessor 126 also access recipe information, either stored internally or received via the near field communications unit 122 and display relevant recipe information messages on the LCD display module 116. These recipe information messages may include information, such as ingredient lists, mixing instructions, baking times, or other relevant recipe details.

The microprocessor 126 is also programmed to interpret user inputs from the touch screen 118, facilitating users to navigate through different functions, select recipes, or adjust settings. Based on these inputs and the data received from various sensors, the microprocessor 126 can provide real-time guidance and feedback throughout the baking process. For instance, the microprocessor 126 can alert users, via the display screen of the LCD display module 116, when ingredients reach the correct temperature, when the correct weight of an ingredient has been added, or when mixing or baking times are complete.

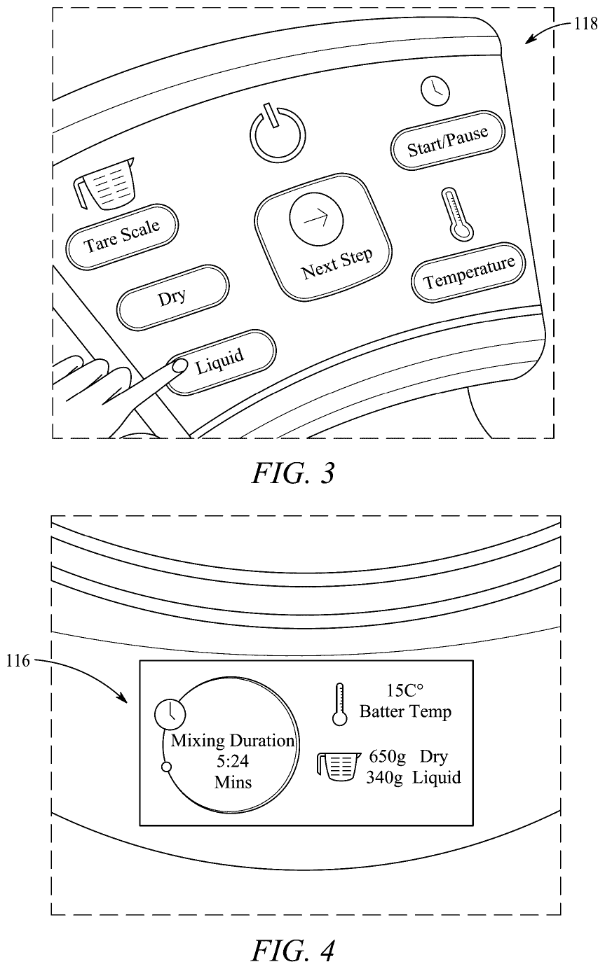

Referring to FIG. 3, illustrated is an exemplary diagram of the touch screen 118 of the baking assistive device 100. As shown, the touch screen 118 of the baking assistive device 100 includes labelled soft touch buttons that provide various functionalities to the user. These soft touch buttons are displayed on the touch screen 118 and respond to user input through touch interactions. These labelled soft touch buttons are designed to be intuitive and easy to use, with clear visual representations and responsive touch sensitivity. The layout of these buttons on the touch screen 118 is designed for ease of access during the baking process. In an example, the labelled soft touch buttons may be made of thermoplastic elastomer (TPE) without any limitations. The microprocessor 126 is programmed to respond to inputs from these soft touch buttons, executing the corresponding functions and updating the display screen on the LCD display module 116 accordingly.

In an aspect of the present disclosure, the touch screen 118 includes a power button, which provides users the ability to turn the baking assistive device 100 on or off. The touch screen 118 also includes a tare scale button configured to zero the weight recorded by the load cell 124. That is, the tare scale button resets the weight measurement to zero, facilitating accurate measurement of ingredients added to the mixing bowl 113. In an example, the tare scale button may be set when an empty mixing bowl 113 is placed on the stainless steel plate 112, in order to set the weight measurement to zero and allow the user to view the weight measurement as related to the ingredients as they are added to the mixing bowl 113 without needing to subtract the weight of the mixing bowl. The touch screen 118 further includes a dry ingredient button and a liquid ingredient button, empowering users to specify the type of ingredient being added for more precise measurements and recipe guidance. The touch screen 118 further includes a next step button configured to advance the recipe information through a set of steps to prepare the recipe. That is, the next step button empowers users to progress through recipe instructions or device functions in a sequential manner. The touch screen 118 further includes a temperature button configured to actuate the infrared temperature sensor 120 to record a temperature of a recipe ingredient in the mixing bowl 113 located on the stainless steel plate 112. That is, the temperature button activates the infrared temperature sensor 120, empowering users to measure the temperature of ingredients or mixtures in the mixing bowl 113. The touch screen 118 further includes a save button to empower users to store recipe information, custom settings, or baking session data for future reference. The touch screen 118 further includes a start/pause button, which empowers users to initiate or temporarily halt timing functions or other ongoing processes in the baking assistive device 100.

Referring to FIG. 4, illustrated is an exemplary diagram of the LCD display module 116 of the baking assistive device 100. Herein, the weight displayed on the display screen of the LCD display module 116 includes a dry weight and a liquid weight. The dry weight represents the measurement of dry ingredients added to the mixing bowl 113. When a user selects the dry ingredient button on the touch screen 118 and adds dry ingredients to the mixing bowl 113, the load cell 124 measures the weight, and the microprocessor 126 processes this data as dry weight. This dry weight is then displayed on the LCD display module 116, typically in units such as grams or ounces. Similarly, the liquid weight represents the measurement of liquid ingredients added to the mixing bowl 113. When a user selects the liquid ingredient button on the touch screen 118 and adds liquid ingredients to the mixing bowl 113, the load cell 124 measures the weight, and the microprocessor 126 processes this data as liquid weight. The liquid weight is displayed on the LCD display module 116, typically in units such as grams or ounces, or alternatively in volume units such as milliliters or fluid ounces. The microprocessor 126 is configured to process and display these weight measurements separately, providing users with more relevant information for recipe preparation.

Further, the recipe information message located on the display screen of the LCD display module 116 includes a recipe instruction, a mixing duration, and a next ingredient. These components are designed to guide the user through the baking process in a clear and organized manner. Herein, the recipe instruction displayed on the LCD display module 116 provides step-by-step guidance for the current stage of the baking process. These recipe instructions are provided by the microprocessor 126 based on the selected recipe and the current progress. The instructions may include actions such as “Add flour to the mixing bowl” or “Preheat oven to 350° F.”. The mixing duration indicates the recommended time for mixing the current set of ingredients. This mixing duration is typically presented in minutes and seconds and may be accompanied by a countdown timer that the user can activate using the start/pause button on the touch screen 118. The microprocessor 126 manages this timing function, alerting the user when the mixing duration is complete. The next ingredient information prepares the user for the upcoming step in the recipe. This feature facilitates users to anticipate and prepare for the next step, such as addition of a recipe ingredient to the mixing bowl 113. The microprocessor 126 may retrieve this information from the stored recipe data and displays it on the LCD display module 116, ensuring a smooth progression through the recipe steps. These three components in the recipe information message equip the baking assistive device 100 to provide guidance throughout the baking process, potentially improving the user's efficiency and accuracy and the consistency of their baking results.

In the present configuration of the baking assistive device 100, the infrared temperature sensor 120 is configured to measure the temperature of the recipe ingredients when the recipe instruction (as displayed on the LCD display module 116) is a mixing duration. For this purpose, during mixing phases of the recipe, the microprocessor 126 activates the infrared temperature sensor 120 to continuously or intermittently measure the temperature of the ingredients in the mixing bowl 113. This functionality equips the baking assistive device 100 to monitor temperature changes that occur during the mixing process. The temperature data collected by the infrared temperature sensor 120 is processed by the microprocessor 126 and can be displayed on the LCD display module 116 alongside the mixing duration information. This real-time temperature monitoring empowers users to ensure that ingredients are at the correct temperature during mixing, for achieving desired outcomes in temperature-sensitive recipes. The microprocessor 126 can also use this temperature data to provide alerts or adjust mixing duration recommendations if the ingredient temperature deviates significantly from the recipe requirements.

Also, the LED light ring 110 is configured to provide visual feedback to the user during the ingredient addition process. In particular, the LED light ring 110 is configured to emit a red light as a recipe ingredient is received within the mixing bowl 113 until a desired weight is reached and emit a blue light when the weight of the recipe ingredient equals the desired weight. That is, as a recipe ingredient is received within the mixing bowl 113, the LED light ring 110 is programmed to emit the red light. This red light serves as a visual indicator that the current weight of the added ingredient, as measured by the load cell 124, has not yet reached the desired weight specified in the recipe. The microprocessor 126 continuously compares the weight data received from the load cell 124 with the desired weight for the current ingredient, as specified in the recipe data. When the weight of the recipe ingredient in the mixing bowl 113 equals the desired weight, the microprocessor 126 signals the LED light ring 110 to switch from the red light to the blue light. This blue light serves as a visual cue to the user that the correct amount of the ingredient has been added to the mixing bowl 113. This color-coded feedback system of the LED light ring 110 provides an easily visible guide for users, complementing the weight display on the LCD display module 116.

In a further aspect of the present disclosure, the LED light ring 110 is configured to emit a blue light when the recipe instruction is a mixing duration and a red light when the mixing duration has expired. Herein, when the recipe instruction displayed on the LCD display module 116 is a mixing duration, the microprocessor 126 signals the LED light ring 110 to emit a blue light. This blue light serves as a visual indicator to the user that a mixing operation is currently in progress. The microprocessor 126 then tracks the elapsed time of the mixing duration. Throughout the specified mixing duration, the LED light ring 110 continues to emit the blue light, providing a constant visual reminder to the user that mixing should be ongoing. When the mixing duration has expired, as determined by the microprocessor 126, the LED light ring 110 is signaled to switch from blue to red light. This transition to red light serves as a visual alert to the user that the specified mixing time has been completed.

In an aspect of the present disclosure, the components of the baking assistive device 100 are manufactured using injection molding techniques. Injection molding involves injecting molten plastic material into pre-designed molds that shape the components to their specified dimensions and forms. This manufacturing process is applied to form the base structure 102, the cover ring 104, the curved arm 106, the support ring 108, and other structural elements of the baking assistive device 100. The injection molding process facilitates forming of the hollow interior of the base structure 102, to facilitate housing of various electronic components such as the microprocessor 126, the load cell 124, and the near field communications unit 122 inside thereof. The precision of injection molding further facilitates the creation of snap-fit connections, such as those between the base structure 102 and the cover ring 104, facilitating easy assembly and disassembly for maintenance. In one or more example, the base structure 102 and the curved arm 106 are made of ABS plastic with a glossy paint finish. The cover ring 104 and support ring 108 may also be formed of same material without any limitations. Further, the translucent light diffuser ring 114 may be formed of polycarbonate plastic, which is a transparent thermoplastic known for its high impact resistance, heat resistance, and clarity.

Further, in an aspect of the present disclosure, the baking assistive device 100 operates on a 220 Voltage electrical supply. The infrared temperature sensor 120 of the baking assistive device 100 has a temperature measuring range from −20° C. to 100° C., with an accuracy of about 0.5° C. The load cell 124 has a weighing range of up to 5 KG, providing for precise measurement of ingredients. The LCD display module 116 may provide a screen resolution of 128×64 pixels, measuring 2.2 inches diagonally. In some examples, the baking assistive device 100 may include rubber feet at bottom of the base structure 102 to provide extra stability. Regarding dimensions, the baking assistive device 100 has a total height of about 260 mm, with the curved arm 106 rising to a height of about 170 mm. The base structure 102 has a diameter of about 290 mm, providing a stable foundation. The stainless steel plate 112 has a diameter of about 270 mm, providing sufficient space for placing the mixing bowl 113 thereon. The curved arm 106 may extend at a 45° angle from the base structure 102, with the touch screen 118 at its top measuring about 170 mm in width and 35 mm in height. These dimensions and specifications ensure that the baking assistive device 100 is compact enough for countertop use while providing sufficient capacity and functionality for home baking needs.

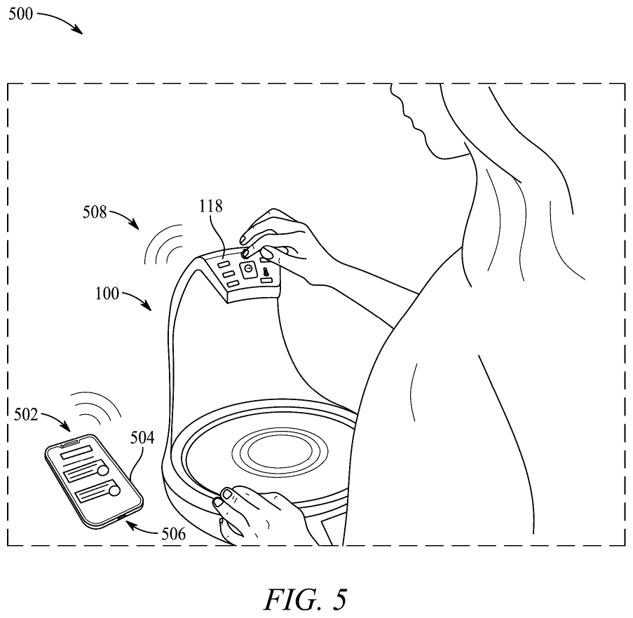

Referring now to FIG. 5, illustrated is an exemplary depiction of a baking assistive system (as represented by reference numeral 500). The baking assistive system 500 incorporates the baking assistive device 100 as discussed in the preceding paragraph. The baking assistive system 500 also includes or utilizes a smartphone 502, which may be a smartphone available to the user. The smartphone 502 has a display 504 for displaying information related to the baking process. The smartphone 502 is configured with a baking assistive computer application 506, which provides the required information related to the baking process to be displayed on the display 504. As discussed, the baking assistive device 100 includes the near field communications unit 122 located within the hollow interior of the base structure 102. The smartphone 502 is designed to pair with the baking assistive device 100 over a near field communication channel (as represented by reference numeral 508), establishing a wireless connection between the two devices.

In the baking assistive system 500, the baking assistive computer application 506 on the smartphone 502 is configured to receive a recipe selection from the user. The baking assistive system 500 includes a recipe database (not shown), accessible by the baking assistive computer application 506 and which may be stored locally on the smartphone 502 or accessed remotely. The recipe database includes recipes having recipe ingredients and recipe instructions for preparing the recipe selection. That is, this recipe database contains recipes with detailed information on recipe ingredients and recipe instructions for preparing the selected recipe. Further, the smartphone 502 is configured to display the recipe selection and the recipe ingredients. Specifically, the display 504 located on the smartphone 502 is configured to display the recipe selection and the recipe ingredients. This visual presentation on the smartphone 502 empowers users to review recipe details and ingredient lists conveniently. Furthermore, the near field communications unit 122 is configured to pair with the smartphone 502 to receive the recipe instructions for preparing the recipe ingredients. This wireless data transfer ensures that the baking assistive device 100 has access to the necessary recipe information.

The microprocessor 126, located within the hollow interior of the base structure 102 of the baking assistive device 100, is connected to the near field communications unit 122. The microprocessor 126 is configured to receive the recipe ingredients and recipe instructions, as transmitted from the smartphone 502 via the near field communications unit 122. The LCD display module 116, located on an outside surface of the base structure 102 of the baking assistive device 100, is operatively connected to the microprocessor 126. The microprocessor 126 is configured to display the recipe instructions for preparing the recipe selection on the LCD display module 116. This feature provides users with ability to view recipe instructions directly on the baking assistive device 100 while performing baking tasks, without needing to refer back to the smartphone 502.

The baking assistive system 500 incorporates all components and functionalities of the baking assistive device 100 as described in the preceding paragraphs. These components include, but are not limited to, the base structure 102 with its hollow interior, the cover ring 104, the curved arm 106 with its first end 106a connected to the cover ring 104, the support ring 108, the LED light ring 110, the stainless steel plate 112, the translucent light diffuser ring 114, the LCD display module 116, and the touch screen 118 connected to the second end 106b of the curved arm 106. The baking assistive system 500 also includes the infrared temperature sensor 120 located near the second end 106b of the curved arm 106, and the load cell 124 within the hollow interior of the base structure 102. The microprocessor 126, as previously described, is connected to these components and is configured to display the weight, the temperature, and the recipe information messages on the LCD display module 116. The touch screen 118 of the baking assistive system 500 includes the labelled soft touch buttons as detailed earlier, including the power button, the tare scale button, the dry ingredient button, the liquid ingredient button, the next step button, the temperature button, the save button, and the start/pause button. Furthermore, the baking assistive system 500 retains all functionalities related to the weight display (including dry and liquid weight), the recipe information messages (including recipe instructions, the mixing durations, and the next ingredient information), and the use of the mixing bowls 113 as described for the baking assistive device 100. The LED light ring 110 in the baking assistive system 500 maintains its color-coded feedback system for the ingredient addition and the mixing durations. The infrared temperature sensor 120 in the baking assistive system 500 focuses the infrared beam on the center of the mixing bowl 113 and measure ingredient temperatures during mixing durations. These components and functionalities are integral to the baking assistive system 500 and operate in the same manner as described for the baking assistive device 100. For brevity, the detailed descriptions of these elements are not repeated for brevity of the present disclosure, but it should be understood that they are fully incorporated into the baking assistive system 500 and function as previously described.

The baking assistive system 500 extends the functionality of the baking assistive device 100 by integrating it with the smartphone 502 and the baking assistive computer application 506. This integration supports enhanced recipe management and guidance. The baking assistive system 500 empowers users to select recipes through the baking assistive computer application 506 via the smartphone 502, which then communicates with the baking assistive device 100 via the near field communication. This feature provides access to the recipe database. The baking assistive system 500 further facilitates transfer of the recipe instructions and the ingredient information from the smartphone 502 to the baking assistive device 100, providing users with the ability to view recipe details on both the smartphone display 504 and the LCD display module 116 of the baking assistive device 100. Such configuration enhances user convenience and flexibility during the baking process, combining the detailed recipe information available on the smartphone 502 with the real-time guidance and measurement capabilities of the baking assistive device 100.

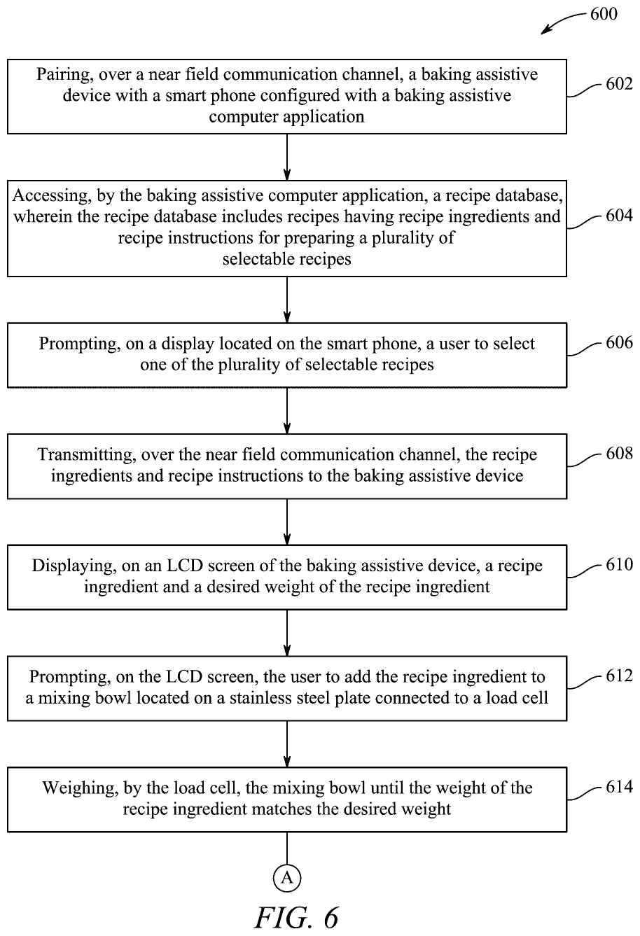

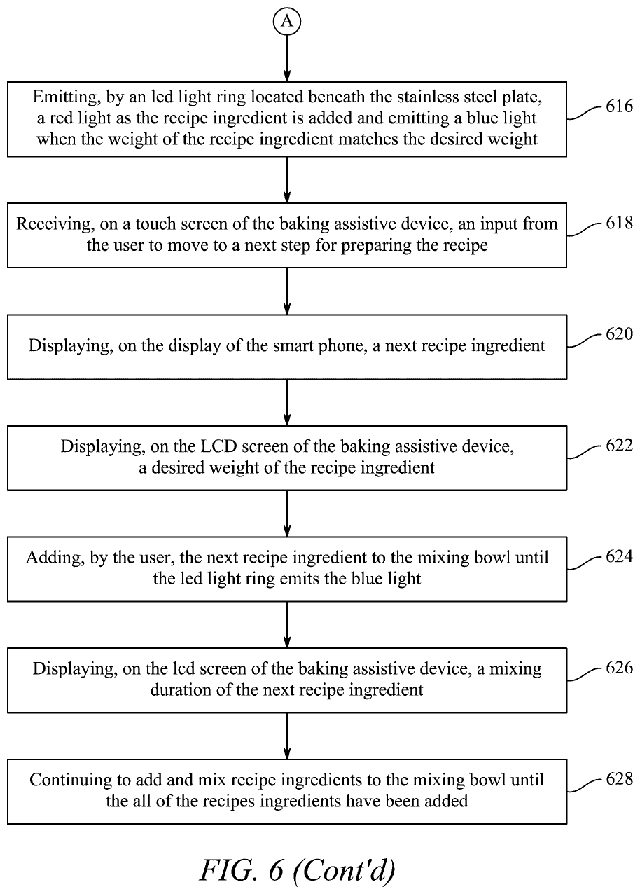

Referring to FIG. 6, the present disclosure further provides a method (as represented by a flowchart, referred by reference numeral 600) for preparing a recipe using the baking assistive system 500. The method 600 includes a series of steps. These steps are only illustrative, and other alternatives may be considered where one or more steps are added, one or more steps are removed, or one or more steps are provided in a different sequence without departing from the scope of the present disclosure. Various variants disclosed above, with respect to the aforementioned baking assistive device 100 and baking assistive system 500 apply mutatis mutandis to the present method 600.

At step 602, the method 600 includes pairing, over the near field communication channel 508, the baking assistive device 100 with the smartphone 502 configured with the baking assistive computer application 506. That is, the method 600 begins with pairing the baking assistive device 100 with the smartphone 502 over the near field communication channel 508. The smartphone 502 is configured with the baking assistive computer application 506. This pairing process establishes a wireless connection between the baking assistive device 100 and the smartphone 502, facilitating data transfer between the two devices.

At step 604, the method 600 includes accessing, by the baking assistive computer application 506, the recipe database. Herein, the recipe database includes recipes having recipe ingredients and recipe instructions for preparing a plurality of selectable recipes. Such recipe database may be stored locally on the smartphone 502 or accessed remotely through a network connection.

At step 606, the method 600 includes prompting, on the display 504 located on the smartphone 502, a user to select one of the plurality of selectable recipes. Specifically, the baking assistive computer application 506 prompts a user to select one of the plurality of selectable recipes. This prompt is displayed on the display 504 located on the smartphone 502. The user interface of the baking assistive computer application 506 may present recipe options in various formats, such as a scrollable list or categorized menu, empowering the user to browse and select their desired recipe.

At step 608, the method 600 includes transmitting, over the near field communication channel 508, the recipe ingredients and recipe instructions to the baking assistive device 100. That is, once a recipe is selected, the method 600 proceeds to transmit the recipe ingredients and recipe instructions to the baking assistive device 100. This transmission occurs over the previously established near field communication channel 508. The transmitted data includes all necessary information for preparing the selected recipe, including ingredient lists, quantities, and step-by-step instructions.

At step 610, the method 600 includes displaying, on the LCD display module 116 of the baking assistive device 100, a recipe ingredient and a desired weight of the recipe ingredient. This information is processed by the microprocessor 126 of the baking assistive device 100 and presented to the user, providing guidance on which ingredient to add next and the precise quantity required. The LCD display module 116 may also show additional information such as the current weight measured by the load cell 124, empowering the user to accurately add the ingredient to the mixing bowl 113.

At step 612, the method 600 includes prompting, on the LCD display module 116, the user to add the recipe ingredient to the mixing bowl 113 located on the stainless steel plate 112 connected to the load cell 124. That is, the method 600 continues with the LCD display module 116 of the baking assistive device 100 prompting the user to add the recipe ingredient to the mixing bowl 113. The mixing bowl 113 is located on the stainless steel plate 112, which is connected to the load cell 124. This prompt guides the user to the next action in the recipe preparation process.

At step 614, the method 600 includes weighing, by the load cell 124, the mixing bowl 113 until the weight of the recipe ingredient matches the desired weight. Herein, the load cell 124 is employed to weigh the mixing bowl 113 as the recipe ingredient is added. The load cell 124 continuously measures the weight until it matches the desired weight of the recipe ingredient. This real-time weight measurement facilitates the process of precise ingredient addition.

At step 616, the method 600 includes emitting, by the LED light ring 110 located beneath the stainless steel plate 112, the red light as the recipe ingredient is added and emitting the blue light when the weight of the recipe ingredient matches the desired weight. Herein, the LED light ring 110 provides visual feedback during the ingredient addition process. The LED light ring 110 emits the red light as the recipe ingredient is being added to the mixing bowl 113. When the weight of the added ingredient matches the desired weight, as determined by the load cell 124 and processed by the microprocessor 126, the LED light ring 110 switches to emitting the blue light. This color change provides a visual cue to the user that the correct amount of the ingredient has been added.

At step 618, the method 600 includes receiving, on the touch screen 118 of the baking assistive device 100, an input from the user to move to a next step for preparing the recipe. This input indicates the user's readiness to move to the next step in preparing the recipe. The touch screen 118 may display a “Next” button or similar interface element for this purpose.

At step 620, the method 600 includes displaying, on the display 504 of the smartphone 502, a next recipe ingredient. That is, following the user input, the method 600 continues with the smartphone 502 displaying the next recipe ingredient on its display 504. This information is presented through the baking assistive computer application 506, providing the user with advance notice of the next ingredient to be added. This step empowers the user to prepare for the upcoming ingredient while still interacting with the baking assistive device 100 for the current step.

At step 622, the method 600 includes displaying, on the LCD display module 116 of the baking assistive device 100, a desired weight of the recipe ingredient. This information is processed by the microprocessor 126 and presented to guide the user in adding the correct amount of the next recipe ingredient.

At step 624, the method 600 includes adding, by the user, the next recipe ingredient to the mixing bowl 113 until the LED light ring 110 emits the blue light. The LED light ring 110 continues to provide visual feedback during this process, emitting the red light as the ingredient is being added. The user continues to add the ingredient until the LED light ring 110 starts emitting the blue light, indicating that the correct weight has been reached as measured by the load cell 124.

At step 626, the method 600 includes displaying, on the LCD display module 116 of the baking assistive device 100, a mixing duration of the next recipe ingredient. That is, once the correct weight of the ingredient has been added, the LCD display module 116 of the baking assistive device 100 displays a mixing duration for the next recipe ingredient. This mixing duration is determined based on the recipe instructions received from the smartphone 502 and processed by the microprocessor 126.

At step 628, the method 600 includes continuing to add and mix recipe ingredients to the mixing bowl 113 until all of the recipes ingredients have been added. Herein, the method 600 continues with the user adding and mixing recipe ingredients in the mixing bowl 113 as directed by the baking assistive device 100. This process of adding ingredients, weighing them, and mixing for specified durations continues until all of the recipe ingredients have been added.

Throughout this process, the baking assistive device 100 provides guidance through the LCD display module 116, weight feedback through the load cell 124, and visual cues through the LED light ring 110.

In the method 600, the baking assistive device 100 and the smartphone 502 (as part of the baking assistive system 500) work together to guide the user through each step of the recipe. The baking assistive device 100, with the load cell 124, the infrared temperature sensor 120, the LED light ring 110, and the LCD display module 116, provides real-time feedback and guidance on ingredient quantities, temperatures, and mixing durations. Simultaneously, the smartphone 502, through the baking assistive computer application 506, provides detailed recipe information and progress tracking. This integrated approach, facilitated by the near field communication channel 508 between the baking assistive device 100 and the smartphone 502, enhance the baking experience for users, potentially improving the consistency and quality of their baked goods while simplifying the baking process.

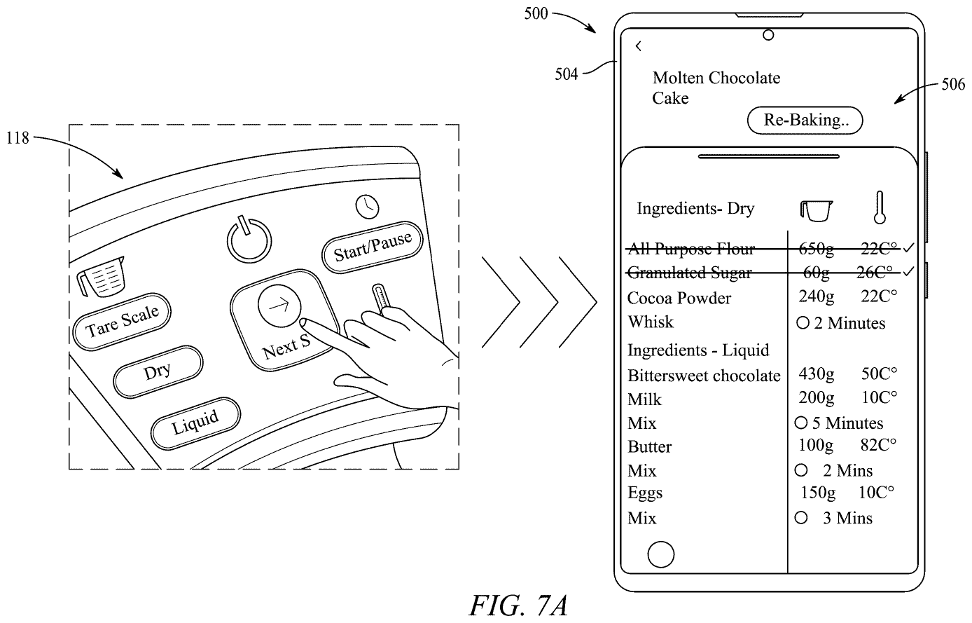

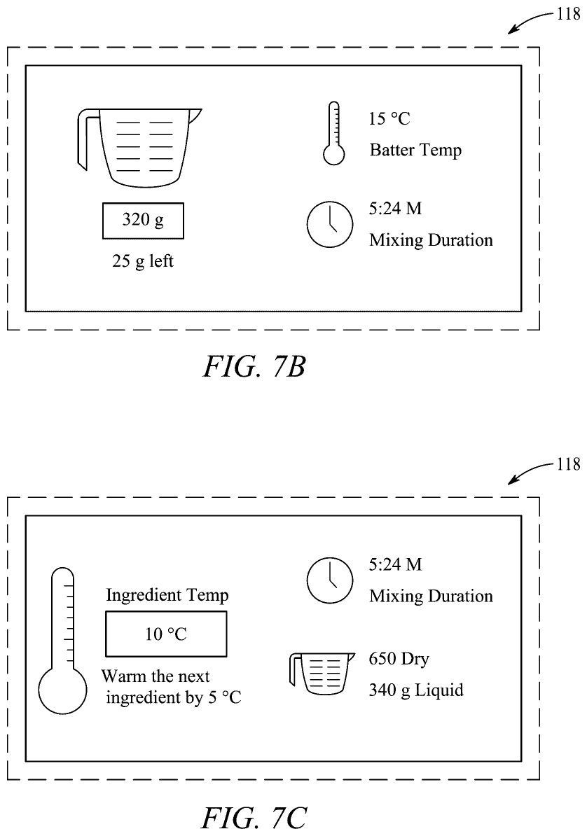

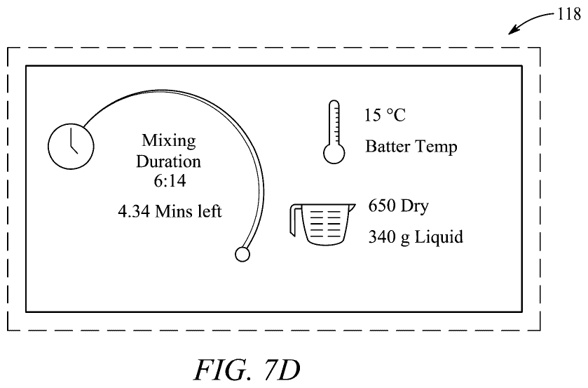

FIG. 7A is an exemplary diagram illustrating a first usage scenario of the baking assistive device 100. This first usage scenario involves the touch screen 118 of the baking assistive device 100 and the display 504 of the smartphone 502. The touch screen 118 of the baking assistive device 100 provide several buttons. The display 504 of the smartphone 502 presents the baking assistive computer application 506, providing a recipe for “Molten Chocolate Cake”. The recipe is divided into dry and liquid ingredients, listing quantities and required temperatures for each. Herein, the user is shown interacting with the next step button, indicating progression through the recipe steps. This interaction serves as a confirmation that the user has manually added the current ingredient as instructed. Upon this confirmation, the baking assistive computer application 506 on the smartphone 502 visually crosses out the added ingredient in the recipe list, providing a reference for the user of their progress. This action also triggers to proceed to the next step, preparing the baking assistive device 100 to display details of the next ingredient on the LCD display module 116 therein. This scenario highlights the synchronization between the baking assistive device 100 and the smartphone 502 via the near field communication channel 508, providing clear recipe guidance.

FIG. 7B is an exemplary diagram illustrating a second usage scenario of the baking assistive device 100. This second usage scenario involves the LCD display module 116 of the baking assistive device 100 during the ingredient addition process. Herein, the LCD display module 116 shows a mixing bowl icon, representing the mixing bowl 113 placed on the stainless steel plate 112. Below the icon, a weight of ‘320 g’ is displayed, indicating the current weight measured by the load cell 124. The display also shows ‘25 g left’, guiding the user to add more of the current ingredient. The batter temperature, measured by the infrared temperature sensor 120, is shown as ‘15° C.’. A mixing duration of ‘5:24 minutes’ is displayed, which is controlled by the microprocessor 126 based on the recipe instructions received from the smartphone 502. This scenario highlights how the baking assistive device 100 provides real-time feedback on weight, temperature, and timing during the baking process.

FIG. 7C is an exemplary diagram illustrating a third usage scenario of the baking assistive device 100. This third usage scenario shows the LCD display module 116 providing information about ingredient temperature and mixing instructions. The current ingredient temperature, measured by the infrared temperature sensor 120, is displayed as ‘10° C.’. The device instructs the user to ‘Warm the next ingredient by 5° C.’, demonstrating capability of the baking assistive device 100 to guide users in preparing ingredients to the correct temperature. The LCD display module 116 also shows the mixing duration of ‘5:24 minutes’, controlled by the microprocessor 126. The current ingredient quantities are displayed as ‘650 g Dry’ and ‘340 g Liquid’, indicating the measurements from the load cell 124. This scenario highlights ability of the baking assistive device 100 to provide specific instructions for ingredient preparation and to track different types of ingredients separately.

FIG. 7D is an exemplary diagram illustrating a fourth usage scenario of the baking assistive device 100. This fourth usage scenario shows the LCD display module 116 during the mixing process. The mixing duration is shown as ‘6:14 with 4:34 minutes left’, indicating that the mixing process is underway and being timed by the microprocessor 126. The current batter temperature, continuously monitored by the infrared temperature sensor 120, is displayed as ‘15° C.’. The current ingredient quantities are shown as ‘650 g Dry’ and ‘340 g Liquid’, indicating the total amounts measured by the load cell 124. This scenario highlights how the baking assistive device 100 provides real-time information during the baking process, supporting users in monitoring multiple aspects of their recipe simultaneously. The continuous display of temperature and time information supports users in ensuring their baking process remains close to the recipe specifications, potentially improving the consistency and quality of their baked goods.

A first embodiment describes a baking assistive device 100, comprising a base structure 102 having a hollow interior; a cover ring 104 located over the base structure 102; a curved arm 106 having a first end connected to the cover ring 104; a support ring 108 located over the cover ring 104; an LED light ring 110 located over the support ring 108; a stainless steel plate 112 located on the LED light ring 110; a translucent light diffuser ring 114 located on the stainless steel plate 112; an LCD display module 116 located on an exterior surface of the base structure 102; a touch screen 118 connected to a second end of the curved arm 106; an infrared temperature sensor 120 located near the second end of the curved arm 106; a near field communications unit 122 located within the hollow interior of the base structure 102; a load cell 124 located within the hollow interior of the base, wherein the load cell 124 is configured to record a weight based on a depression of the stainless steel plate 112; and a microprocessor 126 located within the hollow interior of the base structure 102, wherein the microprocessor 126 is connected to the load cell 124, the infrared temperature sensor 120, the near field communications unit 122, the LCD display module 116 and the touch screen 118, wherein the microprocessor 126 is configured to display the weight, a temperature and a recipe information message on a display screen of the LCD display module 116.

In an aspect, the curved arm 106 has a curvature of about 45 degrees and is about 230 cm in height; and the touch screen 118 extends at an angle of about 90 degrees from the second end of the curved arm 106.

In an aspect, the touch screen 118 includes labelled soft touch buttons comprising a power button; a tare scale button; a dry ingredient button; a liquid ingredient button; a next step button; a temperature button; a save button; and a start/pause button.

In an aspect, the weight displayed on the display screen of the LCD display module 116 comprises a dry weight; and a liquid weight.

In an aspect, the recipe information message located on the display screen of the LCD display module 116 comprises a recipe instruction; a mixing duration; and a next ingredient.

In an aspect, the baking assistive device 100 further comprises at least one mixing bowl 113, wherein each mixing bowl 113 is configured to rest upon the stainless steel plate 112 and receive at least one recipe ingredient, wherein the load cell 124 is configured to record the weight of the at least one recipe ingredient as the recipe ingredient is received within the mixing bowl 113.

In an aspect, the LED light ring 110 is configured to emit a red light as a recipe ingredient is received within the mixing bowl 113 until a desired weight is reached and emit a blue light when the weight of the recipe ingredient equals the desired weight.

In an aspect, the infrared temperature sensor 120 is installed at an angle on the second end of the curved arm 106, wherein the angle of the infrared temperature sensor 120 is configured to focus an infrared beam on the recipe ingredients in a center of the mixing bowl 113; and the infrared temperature sensor 120 is configured to measure the temperature of the recipe ingredients when the recipe instruction is a mixing duration.

In an aspect, the baking assistive device 100 further comprises a smartphone 502 configured with a baking assistive computer application 506, wherein the baking assistive computer application 506 is configured to receive a recipe selection; a recipe database connected to the smartphone 502, wherein the recipe database includes recipes having recipe ingredients and recipe instructions for preparing the recipe selection; wherein the smartphone 502 is configured to display the recipe selection and the recipe ingredients, wherein the near field communications unit 122 is configured to pair with the smartphone 502 to receive the recipe instructions for preparing the recipe ingredients, wherein the microprocessor 126 is configured to display the instructions for preparing the recipe selection on the LCD display module 116.

In an aspect, the LED light ring 110 is configured to emit a blue light when the recipe instruction is a mixing duration and a red light when the mixing duration has expired.

A second embodiment describes a baking assistive system 500, comprising a baking assistive device 100 including a near field communications unit 122; a smartphone 502 configured with a baking assistive computer application 506, wherein the smartphone 502 is configured to pair with the baking assistive device 100 over a near field communication channel 508; a recipe database connected to the smartphone 502, wherein the recipe database includes recipes having recipe ingredients and recipe instructions for preparing a recipe selection; a display 504 located on the smartphone 502 which is configured to display the recipe selection and the recipe ingredients; a microprocessor 126 located within a hollow interior of a base structure 102 of the baking assistive device 100, wherein the microprocessor 126 is connected to the near field communications unit 122 and is configured to receive the recipe ingredients and the recipe instructions; an LCD display module 116 located on an exterior surface of the base structure 102 of the baking assistive device 100, wherein the LCD display module 116 is operatively connected to the microprocessor 126, wherein the microprocessor 126 is configured to display the recipe instructions for preparing the recipe selection on the LCD display module 116.

In an aspect, the baking assistive device 100 comprises a cover ring 104 located over the base structure 102; a curved arm 106 having a first end connected to the cover ring 104; a support ring 108 located over the cover ring 104; an LED light ring 110 located over the support ring 108; a stainless steel plate 112 located on the LED light ring 110; a translucent light diffuser ring 114 located on the stainless steel plate 112; a touch screen 118 connected to a second end of the curved arm 106, wherein the touch screen 118 is configured to receive inputs which operate the baking assistive device 100; an infrared temperature sensor 120 located near the second end of the curved arm 106, a load cell 124 located within the hollow interior of the base structure 102, wherein the load cell 124 is configured to record a weight based on a depression of the stainless steel plate 112, wherein the microprocessor 126 is further connected to the load cell 124, the infrared temperature sensor 120 and the touch screen 118, wherein the microprocessor 126 is further configured to display the weight, a temperature and a recipe information message on a display screen of the LCD display module 116. In an aspect,

In an aspect, the touch screen 118 includes labelled soft touch buttons comprising a power button; a tare scale button configured to zero the weight recorded by the load cell 124; a dry ingredient button; a liquid ingredient button; a next step button configured to advance the recipe information through a set of steps to prepare the recipe; a temperature button configured to actuate the infrared temperature sensor 120 to record a temperature of a recipe ingredient in a mixing bowl 113 located on the stainless steel plate 112; a save button; and a start/pause button.

In an aspect, the weight displayed on the display screen of the LCD display module 116 comprises a dry weight; and a liquid weight.

In an aspect, the recipe information message located on the display screen of the LCD display module 116 comprises a recipe instruction; a mixing duration; and a next ingredient.

In an aspect, the baking assistive system 500 further comprises at least one mixing bowl 113, wherein each mixing bowl 113 is configured to rest upon the stainless steel plate 112 and receive at least one recipe ingredient, wherein the load cell 124 is configured to record the weight of the at least one recipe ingredient as the recipe ingredient is received within the mixing bowl 113.

In an aspect, the LED light ring 110 is configured to emit a red light as a recipe ingredient is received within the mixing bowl 113 until a desired weight is reached and emit a blue light when the weight of the recipe ingredient equals the desired weight.

In an aspect, the LED light ring 110 is configured to emit a blue light when the recipe instruction is a mixing duration and a red light when the mixing duration has expired.

In an aspect, the infrared temperature sensor 120 is installed at an angle on the second end of the curved arm 106, wherein the angle of the infrared temperature sensor 120 is configured to focus an infrared beam on the recipe ingredients in a center of the mixing bowl 113; and the infrared temperature sensor 120 is configured to measure the temperature of the recipe ingredients when the recipe instruction is a mixing duration.

A third embodiment describes a method for preparing a recipe using a baking assistive system 500, comprising pairing, over a near field communication channel 508, a baking assistive device 100 with a smartphone 502 configured with a baking assistive computer application 506; accessing, by the baking assistive computer application 506, a recipe database, wherein the recipe database includes recipes having recipe ingredients and recipe instructions for preparing a plurality of selectable recipes; prompting, on a display 504 located on the smartphone 502, a user to select one of the plurality of selectable recipes; transmitting, over the near field communication channel 508, the recipe ingredients and recipe instructions to the baking assistive device 100; displaying, on an LCD display module 116 of the baking assistive device 100, a recipe ingredient and a desired weight of the recipe ingredient; prompting, on the LCD display module 116, the user to add the recipe ingredient to a mixing bowl 113 located on a stainless steel plate 112 connected to a load cell 124; weighing, by the load cell 124, the mixing bowl 113 until the weight of the recipe ingredient matches the desired weight; emitting, by an LED light ring 110 located beneath the stainless steel plate 112, a red light as the recipe ingredient is added and emitting a blue light when the weight of the recipe ingredient matches the desired weight; receiving, on a touch screen 118 of the baking assistive device 100, an input from the user to move to a next step for preparing the recipe; displaying, on the display 504 of the smartphone 502, a next recipe ingredient; displaying, on the LCD display module 116 of the baking assistive device 100, a desired weight of the recipe ingredient; adding, by the user, the next recipe ingredient to the mixing bowl 113 until the LED light ring 110 emits the blue light; displaying, on the LCD display module 116 of the baking assistive device 100, a mixing duration of the next recipe ingredient; and continuing to add and mix recipe ingredients to the mixing bowl 113 until the all of the recipes ingredients have been added.

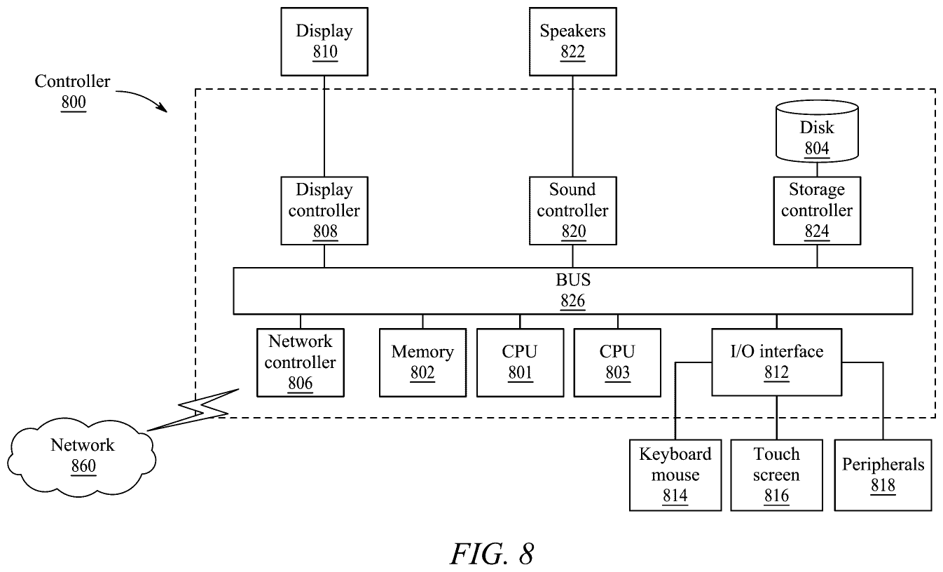

Next, further details of the hardware description of a computing environment according to exemplary embodiments is described with reference to FIG. 8. In FIG. 8, a controller 800 is described is representative of the microprocessor 126 of the baking assistive device 100, in which the controller 800 is a computing device which includes a CPU 801 which performs the processes described above/below. The process data and instructions may be stored in memory 802. These processes and instructions may also be stored on a storage medium disk 804 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 801, 803 and an operating system such as Microsoft Windows 7, Microsoft Windows 8, Microsoft Windows 10, UNIX, Solaris, LINUX, Apple MAC-OS and other systems known to those skilled in the art.

The hardware elements in order to achieve the computing device may be realized by various circuitry elements, known to those skilled in the art. For example, CPU 801 or CPU 803 may be a Xenon or Core processor from Intel of America or an Opteron processor from AMD of America, or may be other processor types that would be recognized by one of ordinary skill in the art. Alternatively, the CPU 801, 803 may be implemented on an FPGA, ASIC, PLD or using discrete logic circuits, as one of ordinary skill in the art would recognize. Further, CPU 801, 803 may be implemented as multiple processors cooperatively working in parallel to perform the instructions of the inventive processes described above.

The computing device in FIG. 8 also includes a network controller 806, such as an Intel Ethernet PRO network interface card from Intel Corporation of America, for interfacing with network 860. As can be appreciated, the network 860 can be a public network, such as the Internet, or a private network such as an LAN or WAN network, or any combination thereof and can also include PSTN or ISDN sub-networks. The network 860 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 808, such as a NVIDIA Geforce GTX or Quadro graphics adaptor from NVIDIA Corporation of America for interfacing with display 810, such as a Hewlett Packard HPL2445w LCD monitor. A general purpose I/O interface 812 interfaces with a keyboard and/or mouse 814 as well as a touch screen panel 816 on or separate from display 810. General purpose I/O interface also connects to a variety of peripherals 818 including printers and scanners, such as an OfficeJet or DeskJet from Hewlett Packard.

A sound controller 820 is also provided in the computing device such as Sound Blaster X-Fi Titanium from Creative, to interface with speakers/microphone 822 thereby providing sounds and/or music.

The general purpose storage controller 824 connects the storage medium disk 804 with communication bus 826, which may be an ISA, EISA, VESA, PCI, or similar, for interconnecting all of the components of the computing device. A description of the general features and functionality of the display 810, keyboard and/or mouse 814, as well as the display controller 808, storage controller 824, network controller 806, sound controller 820, and general purpose I/O interface 812 is omitted herein for brevity as these features are known.

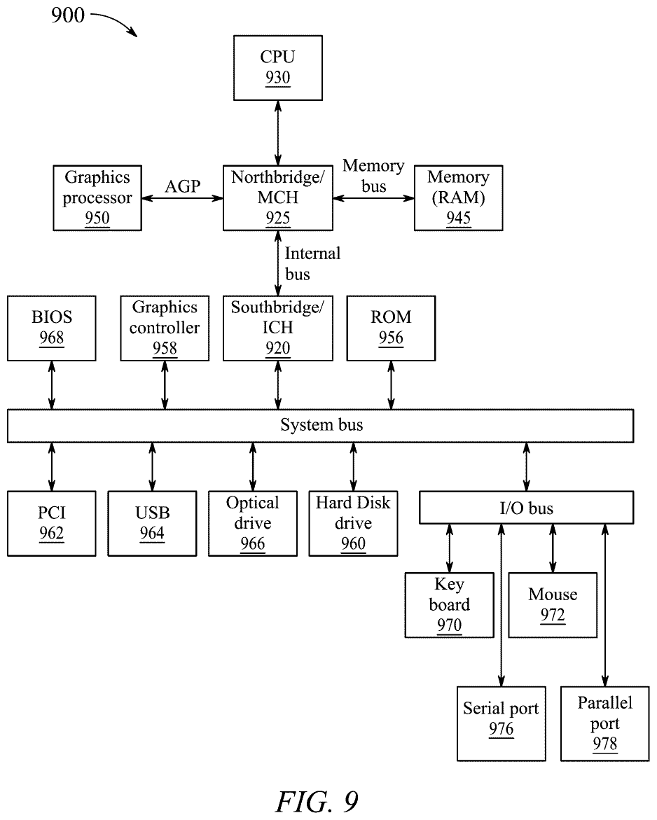

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 9.

FIG. 9 shows a schematic diagram of a data processing system, according to certain embodiments, for performing the functions of the exemplary embodiments. The data processing system is an example of a computer in which code or instructions implementing the processes of the illustrative embodiments may be located.

In FIG. 9, data processing system 900 employs a hub architecture including a north bridge and memory controller hub (NB/MCH) 925 and a south bridge and input/output (I/O) controller hub (SB/ICH) 920. The central processing unit (CPU) 930 is connected to NB/MCH 925. The NB/MCH 925 also connects to the memory 945 via a memory bus, and connects to the graphics processor 950 via an accelerated graphics port (AGP). The NB/MCH 925 also connects to the SB/ICH 920 via an internal bus (e.g., a unified media interface or a direct media interface). The CPU Processing unit 930 may contain one or more processors and even may be implemented using one or more heterogeneous processor systems.

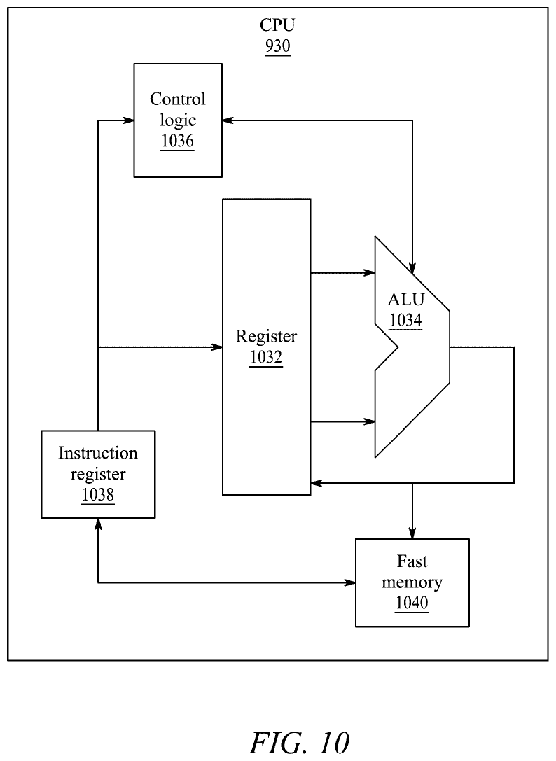

For example, FIG. 10 shows one implementation of CPU 930. In one implementation, the instruction register 1038 retrieves instructions from the fast memory 1040. At least part of these instructions are fetched from the instruction register 1038 by the control logic 1036 and interpreted according to the instruction set architecture of the CPU 930. Part of the instructions can also be directed to the register 1032. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 1034 that loads values from the register 1032 and performs logical and mathematical operations on the loaded values according to the instructions. The results from these operations can be feedback into the register and/or stored in the fast memory 1040. According to certain implementations, the instruction set architecture of the CPU 930 can use a reduced instruction set architecture, a complex instruction set architecture, a vector processor architecture, a very large instruction word architecture. Furthermore, the CPU 930 can be based on the Von Neuman model or the Harvard model. The CPU 930 can be a digital signal processor, an FPGA, an ASIC, a PLA, a PLD, or a CPLD. Further, the CPU 930 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 9, the data processing system 900 can include that the SB/ICH 920 is coupled through a system bus to an I/O Bus, a read only memory (ROM) 956, universal serial bus (USB) port 964, a flash binary input/output system (BIOS) 968, and a graphics controller 958. PCI/PCIe devices can also be coupled to SB/ICH 988 through a PCI bus 962.

The PCI devices may include, for example, Ethernet adapters, add-in cards, and PC cards for notebook computers. The Hard disk drive 960 and CD-ROM 966 can use, for example, an integrated drive electronics (IDE) or serial advanced technology attachment (SATA) interface. In one implementation the I/O bus can include a super I/O (SIO) device.

Further, the hard disk drive (HDD) 960 and optical drive 966 can also be coupled to the SB/ICH 920 through a system bus. In one implementation, a keyboard 970, a mouse 972, a parallel port 978, and a serial port 976 can be connected to the system bus through the I/O bus. Other peripherals and devices that can be connected to the SB/ICH 920 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

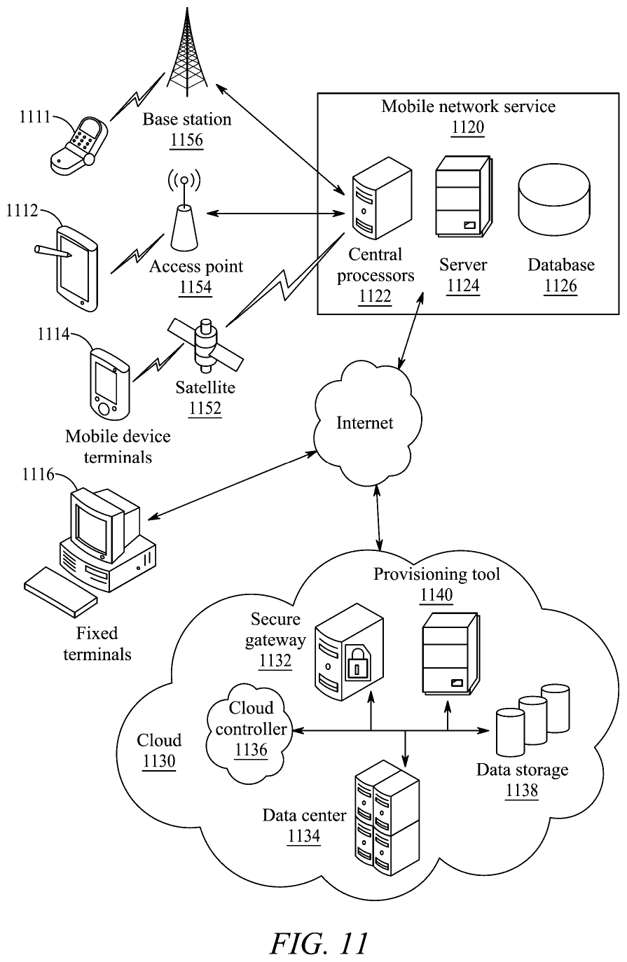

The functions and features described herein may also be executed by various distributed components of a system. For example, one or more processors may execute these system functions, wherein the processors are distributed across multiple components communicating in a network. The distributed components may include one or more client and server machines, such as cloud 1130 including a cloud controller 1136, a secure gateway 1132, a data center 1134, data storage 1138 and a provisioning tool 1140, and mobile network services 1120 including central processors 1122, a server 1124 and a database 1126, which may share processing, as shown by FIG. 11, in addition to various human interface and communication devices (e.g., display monitors 1116, smart phones 1110, tablets 1112, personal digital assistants (PDAs) 1114). The network may be a private network, such as a LAN, satellite 1152 or WAN 1154, or be a public network, may such as the Internet. Input to the system may be received via direct user input and received remotely either in real-time or as a batch process. Additionally, some implementations may be performed on modules or hardware not identical to those described. Accordingly, other implementations are within the scope that may be claimed.

While specific embodiments of the invention have been described, it should be understood that various modifications and alternatives may be implemented without departing from the spirit and scope of the invention. For example, different cellular automata rules or encryption algorithms could be employed, or alternative feature extraction and face recognition techniques could be integrated into the system.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A baking assistive device, comprising:
a base structure having a hollow interior;
a cover ring located over the base structure;
a curved arm having a first end connected to the cover ring;
a support ring located over the cover ring;
an LED light ring located over the support ring;
a stainless steel plate located on the LED light ring;
a translucent light diffuser ring located on the stainless steel plate;
an LCD display module located on an exterior surface of the base structure;
a touch screen connected to a second end of the curved arm;
an infrared temperature sensor located near the second end of the curved arm;
a near field communications unit located within the hollow interior of the base structure;
a load cell located within the hollow interior of the base structure, wherein the load cell is configured to record a weight based on a depression of the stainless steel plate; and
a microprocessor located within the hollow interior of the base structure, wherein the microprocessor is connected to the load cell, the infrared temperature sensor, the near field communications unit, the LCD display module and the touch screen, wherein the microprocessor is configured to display the weight, a temperature and a recipe information message on a display screen of the LCD display module.

2. The baking assistive device of claim 1, wherein:
the curved arm has a curvature of about 45 degrees and is about 230 cm in height; and
the touch screen extends at an angle of about 90 degrees from the second end of the curved arm.

3. The baking assistive device of claim 1, wherein the touch screen includes labelled soft touch buttons comprising:
a power button;
a tare scale button;
a dry ingredient button;
a liquid ingredient button;
a next step button;
a temperature button;
a save button; and
a start/pause button.

4. The baking assistive device of claim 1, wherein the weight displayed on the display screen of the LCD display module comprises:
a dry weight; and
a liquid weight.

5. The baking assistive device of claim 1, wherein the recipe information message located on the display screen of the LCD display module comprises:
a recipe instruction;
a mixing duration; and
a next ingredient.

6. The baking assistive device of claim 5, further comprising:
at least one mixing bowl, wherein each mixing bowl is configured to rest upon the stainless steel plate and receive at least one recipe ingredient, wherein the load cell is configured to record the weight of the at least one recipe ingredient as the recipe ingredient is received within the mixing bowl.

7. The baking assistive device of claim 6, wherein the LED light ring is configured to emit a red light as a recipe ingredient is received within the mixing bowl until a desired weight is reached and emit a blue light when the weight of the recipe ingredient equals the desired weight.

8. The baking assistive device of claim 6, wherein:
the infrared temperature sensor is installed at an angle on the second end of the curved arm, wherein the angle of the infrared temperature sensor is configured to focus an infrared beam on the recipe ingredients in a center of the mixing bowl; and
the infrared temperature sensor is configured to measure the temperature of the recipe ingredients when the recipe instruction is a mixing duration.

9. The baking assistive device of claim 8, further comprising:
a smartphone configured with a baking assistive computer application, wherein the baking assistive computer application is configured to receive a recipe selection;
a recipe database connected to the smartphone, wherein the recipe database includes recipes having recipe ingredients and recipe instructions for preparing the recipe selection;
wherein the smartphone is configured to display the recipe selection and the recipe ingredients,
wherein the near field communications unit is configured to pair with the smartphone to receive the recipe instructions for preparing the recipe ingredients,
wherein the microprocessor is configured to display the instructions for preparing the recipe selection on the LCD display module.

10. The baking assistive device of claim 8, wherein the LED light ring is configured to emit a blue light when the recipe instruction is a mixing duration and a red light when the mixing duration has expired.

11. A baking assistive system, comprising:
a baking assistive device including a near field communications unit;
a smartphone configured with a baking assistive computer application, wherein the smartphone is configured to pair with the baking assistive device over a near field communication channel;
a recipe database connected to the smartphone, wherein the recipe database includes recipes having recipe ingredients and recipe instructions for preparing a recipe selection;
a display located on the smartphone which is configured to display the recipe selection and the recipe ingredients;
a microprocessor located within a hollow interior of a base structure of the baking assistive device, wherein the microprocessor is connected to the near field communications unit and is configured to receive the recipe ingredients and the recipe instructions;
an LCD display module located on an exterior surface of the base structure of the baking assistive device, wherein the LCD display module is operatively connected to the microprocessor, wherein the microprocessor is configured to display the recipe instructions for preparing the recipe selection on the LCD display module.

12. The baking assistive system of claim 11, wherein the baking assistive device comprises:
a cover ring located over the base structure;
a curved arm having a first end connected to the cover ring;
a support ring located over the cover ring;
an LED light ring located over the support ring;
a stainless steel plate located on the LED light ring;
a translucent light diffuser ring located on the stainless steel plate;
a touch screen connected to a second end of the curved arm, wherein the touch screen is configured to receive inputs which operate the baking assistive device;
an infrared temperature sensor located near the second end of the curved arm,
a load cell located within the hollow interior of the base structure, wherein the load cell is configured to record a weight based on a depression of the stainless steel plate,
wherein the microprocessor is further connected to the load cell, the infrared temperature sensor and the touch screen, wherein the microprocessor is further configured to display the weight, a temperature and a recipe information message on a display screen of the LCD display module.

13. The baking assistive system of claim 12, wherein the touch screen includes labelled soft touch buttons comprising:
a power button;
a tare scale button configured to zero the weight recorded by the load cell;
a dry ingredient button;
a liquid ingredient button;
a next step button configured to advance the recipe information through a set of steps to prepare the recipe;
a temperature button configured to actuate the infrared temperature sensor to record a temperature of a recipe ingredient in a mixing bowl located on the stainless steel plate;
a save button; and
a start/pause button.

14. The baking assistive system of claim 13, wherein the weight displayed on the display screen of the LCD display module comprises:
a dry weight; and
a liquid weight.

15. The baking assistive system of claim 14, wherein the recipe information message located on the display screen of the LCD display module comprises:
a recipe instruction;
a mixing duration; and
a next ingredient.

16. The baking assistive system of claim 12, further comprising:
at least one mixing bowl, wherein each mixing bowl is configured to rest upon the stainless steel plate and receive at least one recipe ingredient, wherein the load cell is configured to record the weight of the at least one recipe ingredient as the recipe ingredient is received within the mixing bowl.

17. The baking assistive system of claim 16, wherein the LED light ring is configured to emit a red light as a recipe ingredient is received within the mixing bowl until a desired weight is reached and emit a blue light when the weight of the recipe ingredient equals the desired weight.

18. The baking assistive system of claim 17, wherein the LED light ring is configured to emit a blue light when the recipe instruction is a mixing duration and a red light when the mixing duration has expired.

19. The baking assistive system of claim 16, wherein the infrared temperature sensor is installed at an angle on the second end of the curved arm, wherein the angle of the infrared temperature sensor is configured to focus an infrared beam on the recipe ingredients in a center of the mixing bowl; and
the infrared temperature sensor is configured to measure the temperature of the recipe ingredients when the recipe instruction is a mixing duration.

20. A method for preparing a recipe using a baking assistive system, comprising:
pairing, over a near field communication channel, a baking assistive device with a smartphone configured with a baking assistive computer application;
accessing, by the baking assistive computer application, a recipe database, wherein the recipe database includes recipes having recipe ingredients and recipe instructions for preparing a plurality of selectable recipes;
prompting, on a display located on the smartphone, a user to select one of the plurality of selectable recipes;
transmitting, over the near field communication channel, the recipe ingredients and recipe instructions to the baking assistive device;
displaying, on an LCD display module of the baking assistive device, a recipe ingredient and a desired weight of the recipe ingredient;
prompting, on the LCD display module, the user to add the recipe ingredient to a mixing bowl located on a stainless steel plate connected to a load cell;
weighing, by the load cell, the mixing bowl until the weight of the recipe ingredient matches the desired weight;
emitting, by an LED light ring located beneath the stainless steel plate, a red light as the recipe ingredient is added and emitting a blue light when the weight of the recipe ingredient matches the desired weight;
receiving, on a touch screen of the baking assistive device, an input from the user to move to a next step for preparing the recipe;
displaying, on the display of the smartphone, a next recipe ingredient;
displaying, on the LCD display module of the baking assistive device, a desired weight of the recipe ingredient;
adding, by the user, the next recipe ingredient to the mixing bowl until the LED light ring emits the blue light;
displaying, on the LCD display module of the baking assistive device, a mixing duration of the next recipe ingredient; and
continuing to add and mix recipe ingredients to the mixing bowl until the all of the recipes ingredients have been added.
